(19) United States
(12) Patent Application Publication
(10) Pub. No.: US 2025/0110821 A1
(43) Pub. Date: Apr. 3, 2025

(54) ERROR DEBUGGING NETWORK

(71) Applicant: Apple Inc., Cupertino, CA (US)

(72) Inventors: Mirko SAUERMANN, Neubiberg (DE); Constantin Daniel CIORTESCU, Taufkirchen (DE); Soeren SONNTAG, Haar (DE); Joseph F. CRAMER, Austin, TX (US); Vanja RADOS, San Rafael, CA (US); Matthias HEINK, Munich (DE)

(73) Assignee: Apple Inc., Cupertino, CA (US)

(21) Appl. No.: 18/420,223

(22) Filed: Jan. 23, 2024

Related U.S. Application Data
(60) Provisional application No. 63/586,614, filed on Sep. 29, 2023.

(51) Int. Cl. G06F 11/07

(52) U.S. Cl. CPC G06F 11/0793; G06F 11/0709; G06F 11/0772

(57) ABSTRACT

The present disclosure describes a debugging system that includes an aggregation network and a distribution network. The aggregation network can include leaf nodes and a first root node coupled to the leaf nodes. The leaf nodes can collect error information about error events in a functional circuits and transmit the error information to the first root node. The distribution network can include a second root node coupled to the first root node. The second root node can receive the error information from the first root node and distribute the error information to responding functional circuits to perform an action based on the error information.

### CROSS REFERENCE TO RELATED APPLICATION

This application claims benefit of U.S. Provisional Patent Application No. 63/586,614, filed Sep. 29, 2023, the content of which is incorporated by reference herein in its entirety.

### FIELD

The present disclosure relates to error debugging for a device or a system.

### BACKGROUND

In a computing device or system, debugging is a process of locating and fixing or bypassing bugs (e.g., errors) in computer program code or a hardware device component. To debug a software program or hardware device, the debugging process can include identifying or detecting a bug or an error, isolating the source of the error, and performing an action to fix the error. With the increasing complexity and size of computer systems, efficient and effective debugging processes are increasingly important.

### SUMMARY

Embodiments of the present disclosure include a system having a debugging network for debugging errors in a plurality of subsystems coupled by a communication circuit to detect one or more error events, collect error information about the one or more error events, and to perform one or more actions corresponding to the collected error information. Embodiments herein may be applicable to hardware and software systems.

In some embodiments, a system can include a first subsystem coupled to a second subsystem by a communication circuit and a debugging network. The debugging network can include an aggregation network and a distribution network. The aggregation network includes a first leaf node coupled to a first functional circuit in the first subsystem and a first root node coupled to the first leaf node. The first leaf node is configured to collect a first error information about a first error event in the first functional circuit and to transmit the first error information to the first root node. The distribution network includes a second root node coupled to the first root node and to a second functional circuit in the second subsystem. The second root node is configured to receive the first error information from the first root node and to distribute the first error information to the second functional circuit to perform an action corresponding to the first error information. When the aggregation and the distribution networks are trees, a leaf node may be a leaf node of the tree, and a root node may be a root node of the tree.

In some embodiments, a debugging network can include an aggregation network and a distribution network, and is coupled to a system including subsystems coupled by a communication circuit, where the subsystems include functional circuits. A leaf node of the aggregation network can collect an error information about an error event in an initiator functional circuit of an initiator subsystem, and further transmit the error information from the leaf node to a root node of the aggregation network. Afterwards, a root node of the distribution network can receive the error information from the root node of the aggregation network, and distribute the error information to a responding functional circuit of a responding subsystem, where the error information can cause the responding functional circuit to perform an action corresponding to the error information.

In some embodiments, a debugging network can include an aggregation network and a distribution network. The aggregation network can include leaf nodes coupled to functional circuits and a first root node coupled to the leaf nodes, where the leaf nodes are configured to collect error information about error events in the functional circuits and to transmit the error information to the first root node. The first root node is configured to identify an order of occurrence among the error events. The distribution network includes a second root node coupled to the first root node and to responding functional circuits, where the second root node is configured to receive the error information from the first root node and to distribute the error information to the responding functional circuits to perform an action based on the error information and the order of occurrence among the error events.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIGS. 1A-1D illustrate a system including a debugging network coupled to a plurality of subsystems, according to some embodiments.

FIG. 2 is an illustration of a method to perform debugging operations using a debugging network coupled to a plurality of subsystems, according to some embodiments.

FIG. 3 is an illustration of a system including a debugging network coupled to a plurality of subsystems, according to some embodiments.

FIG. 4 is an illustration of an example computer system for implementing some aspects or portion(s) thereof of the disclosure provided herein, according to some embodiments.

FIG. 5 is an illustration of exemplary systems or devices that can include the disclosed embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

Electronic systems and devices are an essential part of the current society. With the advance of technology, an increasing number of devices, components, and functional circuits can be integrated together to form a more complex system. A system on a chip or system-on-chip (SoC) is an integrated circuit that integrates components or functional circuits of a computer or other electronic system for an application. These components or functional circuits can include a central processing unit (CPU), a processor, a controller, memory interfaces, on-chip input/output devices, input/output interfaces, a peripheral component, a storage component, and secondary storage interfaces—in which one or more of these components or functional circuit can be placed alongside other components, such as radio modems and a graphics processing unit (GPU)—all on a single substrate or microchip. A SoC can include digital, analog, mixed-signal, and radio frequency signal processing functions—to name a few. The components or functional circuits of a SoC can be interconnected via an on-chip data communication network or a communication circuit, such as communication buses or Networks on Chip (NoC). A communication bus can include hardware components (e.g., wire, optical, and fiber components) and software components (e.g., communication protocols). In some embodiments, a communication bus can include an advanced microcontroller bus architecture (AMBA) bus, such as an advanced eXtensible interface (AXI) bus, an advanced high-performance bus (AHB), an advanced peripheral bus (APB), a universal serial bus (USB), an open core protocol (OCP) bus, a peripheral component interconnect express (PCIe) bus, or any other suitable communication bus.

With the increasing size and complexity, a SoC can have errors caused by its functional circuits, including hardware components or software components. An error of a functional circuit can lead to multiple errors in the functional circuit or other additional functional circuits. Given the complexity of the SoC, it can be complex and time-consuming to detect the primary cause of an error and to fix the error. If too much time passes between the generation of the error event and the responsive action performed in response to the error event (e.g., stopping the clock), the system state of the SoC can go through significant modifications after the error event has occurred. Such late error detection can hide the primary cause of the error, increasing the cost of debugging and causing more potential damage to the SoC system or the functions performed. In addition, a SoC can be designed for the intended functions or applications, with no or little consideration for debugging errors of the SoC. Accordingly, an error of a SoC that can occur in field tests may not be diagnosed or remedied due to the limited debug equipment or capability attached to the SoC in operation. On the other hand, such an error may be hard to replicate in the lab where the debugging equipment can be available. Hence, debugging a SoC error can be challenging. It is therefore desirable that the SoC collect error information as soon as possible, such as the system states, on its own in case of an error event (also referred to herein as “a crash dump”). It is further desirable to take actions to identify the root error event and control the damage.

Embodiments herein present a debugging network including an error aggregation and distribution network, which can be applied to a SoC or other systems to enhance debugging capabilities. The debugging network can be connected to all or some of the error sources, such as all or some of the functional circuits of the SoC. The debugging network can keep track of the order of the error events, distribute the error information in a timely manner to various entities or functional circuits, which can stop the system and collect the system state. Accordingly, the debugging network can help freeze the system close in time to the occurrence of an error event.

In some embodiments, the aggregation network can include multiple aggregation nodes, which can be circuits designed to capture error information for the error events, the occurrence order of the error events, and timestamps of the error events. The detected hardware error events and reported software error events can be forwarded to a central point of the aggregation network via other nodes, such as leaf nodes and inner nodes of the aggregation network. An error event is also referred to herein as “an error.”

In some embodiments, the distribution network can receive the error information about the error events from the aggregation network and transmit the error information to dedicated entities to perform different actions based on the received error information. The actions performed can include mechanisms to request a system wide clock-stop followed by a scan-dump. The actions performed can also include interrupting one or more CPUs in the SoC to collect error information programmatically (e.g., crash dump).

Compared to a SoC without a debugging network, embodiments herein can have advantages, including: a low latency response and relay of error events that can trigger a crash in the system; and a fast response to error events to stop the system as close to the point of crash or error as possible to allow for coherent system state capture. In addition, embodiments herein can provide a uniform way to broadcast and react to system crash events. Embodiments herein can also avoid race conditions among different systems crashing, removing an ambiguity of a system crash. Furthermore, embodiments herein can eliminate the “row-of-dominoes mystery,” where it is challenging to assess which error causes a system crash. Embodiments herein can include a systematic record of time via synchronized timers to capture time of crash to sort out what error event occurred first. In addition, embodiments herein can enable or disable (mask) events to enable control of a crash.

Embodiments herein can include a debugging network implemented as a circuit separate from the functional hardware and software of the SoC. Without the debugging network, a plurality of subsystems of the SoC can continue to perform the functions the system or the SoC is designed for. In other words, the presence of the debugging network has little or no impact on function of the system. Embodiments presented herein can be applicable to a SoC using various communication circuits or bus protocols, such as AXI, AHB, APB, OCP, PCIe, or other communication buses.

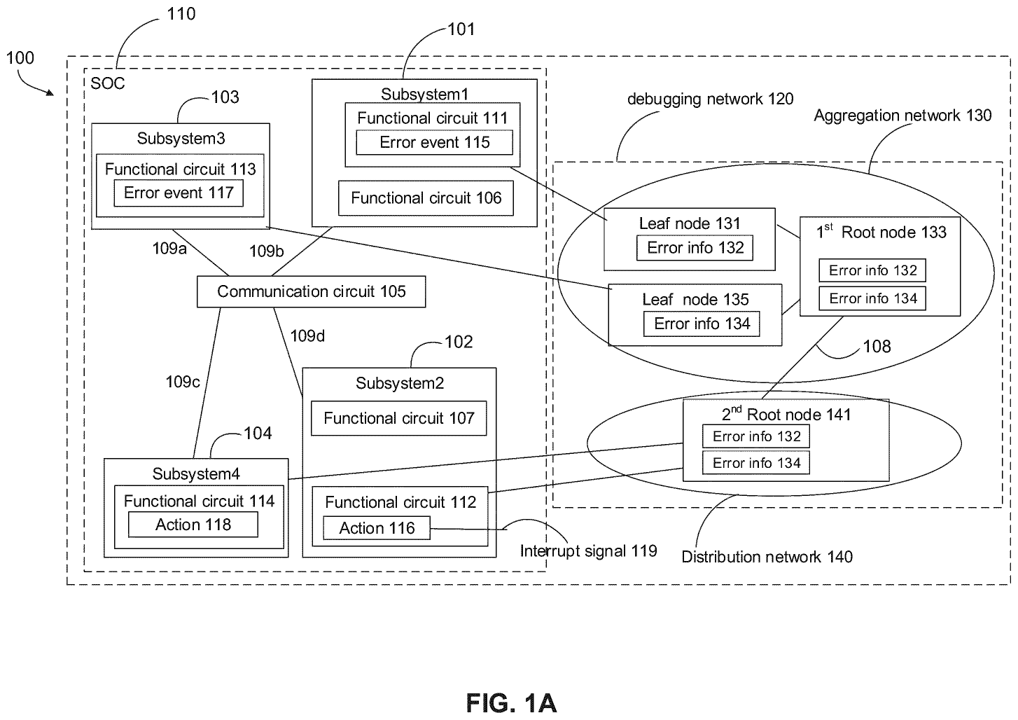

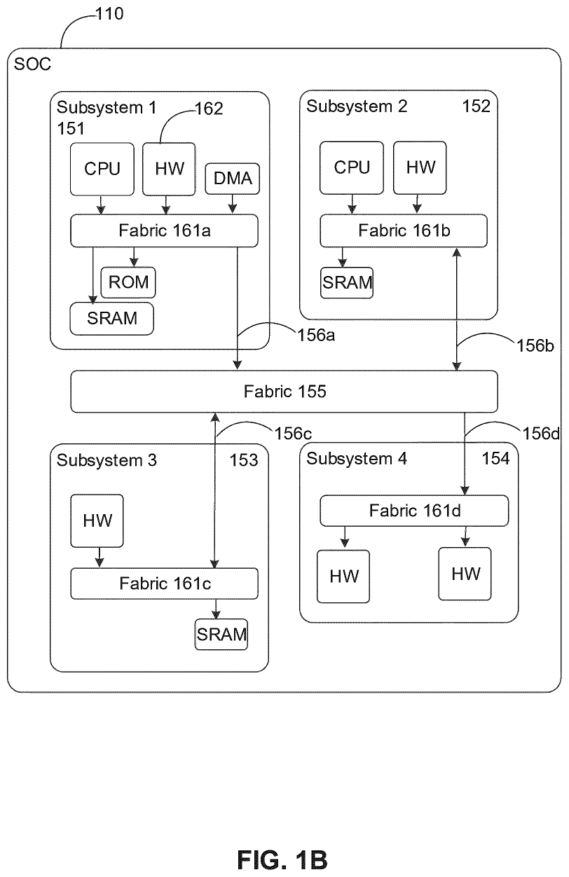

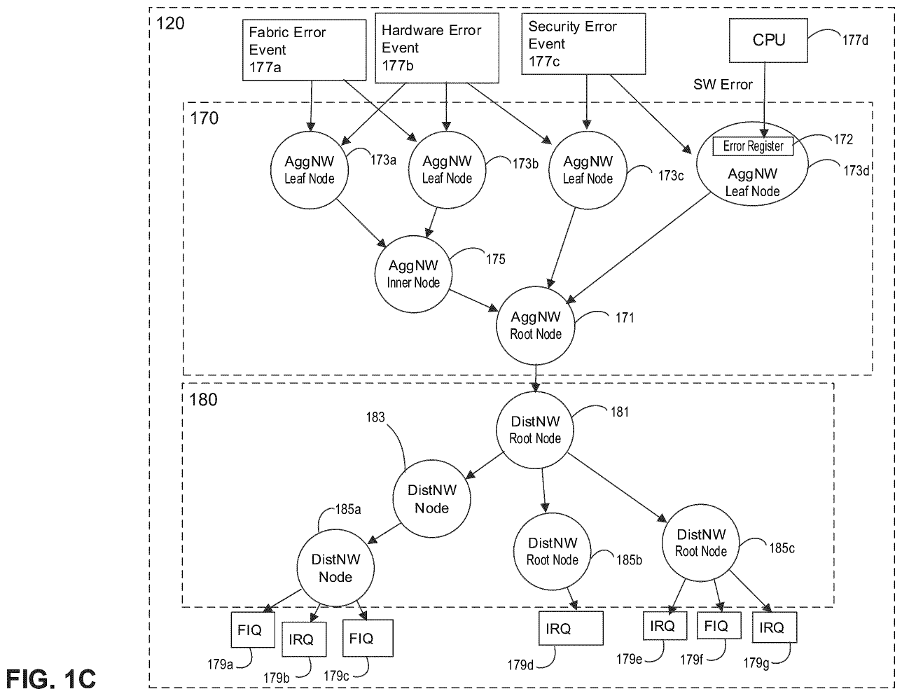

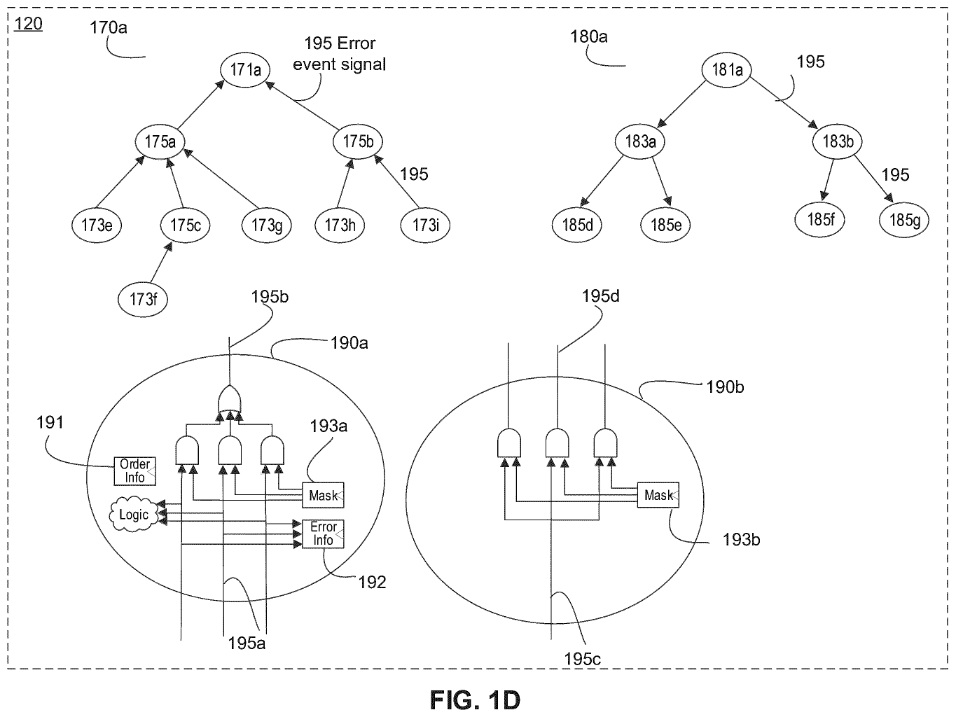

FIGS. 1A-1D illustrate a system 100 including a debugging network 120 coupled to a plurality of subsystems, such as a subsystem 101, a subsystem 102, a subsystem 103, and a subsystem 104, according to some embodiments. Debugging network 120 can include an aggregation network 130 and a distribution network 140. System 100 is provided for the purpose of illustration only and does not limit the disclosed aspects.

In some embodiments, system 100 can include subsystem 101, subsystem 102, subsystem 103, and subsystem 104 coupled together by a communication circuit 105 through a communication bus including various edges or bus segments, such as 109a, 109b, 109c, and 109d. Subsystem 101, subsystem 102, subsystem 103, subsystem 104, and communication circuit 105 can form a system 110 to perform an intended function, such as a wireless communication function for a mobile phone. In some embodiments, system 110 can be a SoC and can have a default error detection and debugging capability while performing the intended function. Debugging network 120 is to increase the default error debugging capability for system 110. In some embodiments, debugging network 120 can increase the default error debugging capability of system 110 without any change to the intended function performed by system 110. In some embodiments, system 110 and debugging network 120 can be located on the same SoC. In some embodiments, system 110 can be located in a SoC and debugging network 120 can be located separately from system 110.

In some embodiments, subsystem 101 can include one or more functional circuits or components, such as a functional circuit 111, a functional circuit 106; subsystem 102 can include one or more functional circuits, such as a functional circuit 112, a functional circuit 107; subsystem 103 can include one or more functional circuits, such as a functional circuit 113; and subsystem 104 can include one or more functional circuits, such as a functional circuit 114. Functional circuit 111, functional circuit 112, functional circuit 113, functional circuit 114, functional circuit 106, and functional circuit 107 can be a processor, a controller, a peripheral component, a storage component, a network component, a multimedia processing component, a security function component, an error correction or encoding component, a timer, an analog circuit component, a Field Programmable Gate Array (FPGA) component, other suitable types of functional components, or combinations thereof, where any of the components can include a digital circuit, an analog circuit, or a mixed signal circuit.

In some embodiments, debugging network 120 can include aggregation network 130 and distribution network 140. Aggregation network 130 can include one or more leaf nodes, such as a first leaf node 131 and a second leaf node 135, which can be coupled to a first root node 133. The first leaf node 131 can be further coupled to functional circuit 111 in subsystem 101. In some embodiments, first leaf node 131 can be included in subsystem 101.

In some embodiments, distribution network 140 can include a second root node 141 coupled to first root node 133 through an edge 108 and to functional circuit 112 in subsystem 102. In some embodiments, first root node 133 and second root node 141 can be implemented in a single node to perform functions of both first root node 133 and second root node 141. In some embodiments, a node, such as first leaf node 131, second leaf node 135, first root node 133, second root node 141, can be any circuit or device performing the functions described herein. For example, first leaf node 131 and second leaf node 135 can collect error information about error events in functional circuits, and first root node 133, second root node 141 can receive the error information from the leaf nodes and distribute the error information to functional circuits.

In some embodiments, first leaf node 131 can be configured to collect a first error information 132 about a first error event 115 in functional circuit 111 and to transmit first error information 132 to first root node 133. In some embodiments, there can be more than a single event going into the first leaf node 131. In some embodiments, error information 132 can include various information, such as an indication of the occurrence of the error event, the location of the error event, and the nature of the error event. In some embodiments, the transmitted error information may only include an error event signal indicating the occurrence of the error event, while other error information may be saved locally without being transmitted. In some embodiments, first error event 115 can be detected by functional circuit 111. Second root node 141 can be configured to receive first error information 132 from first root node 131 and to distribute first error information 132 to functional circuit 112 to perform an action 116 corresponding to the first error information 132. In some embodiments, error information can be stored in the nodes up to the first root node 133 and not stored in the distribution network that includes root node 141. Action 116 can be triggered by an interrupt signal 119, which can be determined based on first error information 132.

In some embodiments, first error event 115 can include a non-recoverable error, a fabric error or bus occurring in communication circuit 105, a security error caused by security violations, an overflow or underflow of an internal hardware resource of the system, a memory allocation error, an invalid access detected by a memory controller, or other error. Action 116 can be triggered by interrupt signal 119, and interrupt signal 119 can include a fast interrupt request (FIQ) signal, a non-maskable interrupt (NMI) signal, an Interrupt ReQuest (IRQ) signal, or other types of interrupt signals. Action 116 can include an action to request a system-wide clock stop, an action to scan out and provide all stored values in various storage circuits known as a “scan-dump,” an action to interrupt one or more processors in the system, or an action to collect error information programmatically by a crash dump.

In some embodiments, system 100 can include a first communication path coupling a starting functional circuit, such as functional circuit 106, to an end functional circuit, such as functional circuit 107, through communication circuit 105 and edge 109b or edge 109d. In addition, system 100 can include a second communication path coupling functional circuit 111 and functional circuit 112 through aggregation network 130 and distribution network 140 through first root node 133 and second root node 141 coupled by edge 108. In some embodiments, debugging network 120 performs the debugging function independently from the intended function performed by system 110. Accordingly, the first communication path and the second communication path may differ in at least one functional circuit or an edge. For example, the first communication path may include communication circuit 105, and the second communication path may not include communication circuit 105, where communication circuit 105 couples functional circuit 111 and functional circuit 112 to perform the intended function for system 110. In some embodiments, edge 108 in debugging network 120 is not included in any communication path in system 110. In some embodiments, communication circuit 105 may not be included in any communication path in debugging network 120.

In some embodiments, system 100 can further include additional subsystems, such as subsystem 103, and subsystem 104, coupled to subsystem 101 and subsystem 102 by communication circuit 105. Aggregation network 130 can further include second leaf node 135 coupled to functional circuit 103. Second leaf node 135 can be configured to collect a second error information 134 about a second error event 117 in functional circuit 113 and to transmit second error information 134 to first root node 133. First root node 133 can be configured to identify an order of occurrence between first error event 115 and second error event 117. Second root node 141 can be configured to receive second error information 134 and to distribute second error information 134 to functional circuit 114 to perform a second action 118 corresponding to second error information 134. In some embodiments, first error information 132 can include a first timestamp of first error event 115, and second error information 134 can include a second timestamp of second error event 117. First root node 133 can identify the order of occurrence between the first error event 115 and the second error event 117 based on the first timestamp and the second timestamp. In some embodiments, error events can include a buffer overflow or underflow, a timeout, a no-access, a malformed request, an invalid request, a hardware malfunction, a conflicting request, and other types of error events. Error information can include an indication of the occurrence of an error event, a time stamp, an order of the error occurrence, a global system time, a clock cycle counter, a location of the error event, a context of the error event, a network time protocol (NTP) based time for the error event, or any other error event information system 110 is designed to capture.

In some embodiments, FIG. 1B illustrates an example of system 110 in system 100. System 110 can include a subsystem 151, a subsystem 152, a subsystem 153, and a subsystem 154 coupled by a fabric circuit or a fabric 155, which can be examples of subsystem 101, subsystem 102, subsystem 103, subsystem 104, and communication circuit 105, respectively, as shown in FIG. 1A. Subsystem 151, subsystem 152, subsystem 153, and subsystem 154 can be coupled to fabric 155 by a communication bus 156a, 156b, 156c, and 156d, respectively. Subsystem 151 can include a fabric 161a coupling a plurality of functional circuits including a central processing unit (CPU) having one or more processing cores of similar or differing capabilities, a hardware component (HW) 162, and various storage circuits such as a direct memory access (DMA) component, a read-only memory (ROM), a static random-access memory (SRAM); subsystem 152 can include a fabric 161b coupling a plurality of functional circuits including a CPU, a HW, and a SRAM; subsystem 153 can include a fabric 161c coupling a plurality of functional circuits including a SRAM and a HW; and subsystem 154 can include a fabric 161d coupling a plurality of functional circuits including two HWs. In some embodiments, system 110 can exchange data via a fabric of any topology that may be different from the topology of system 110 shown in FIG. 1B.

In some embodiments, a HW, such as HW 162, can be a functional circuit, a demultiplexer, a security circuit, a multiplexer, a power circuit, a processor, a hardware accelerator, a controller, a memory interface, an on-chip input/output device, an input/output interface, a peripheral component, a storage component, a secondary storage interface, a radio modem, a graphics processing unit (GPU), a digital component, an analog component, a mixed-signal component, or a component performing radio frequency signal processing functions. In some embodiments, a HW, such as HW 162, can include an error detection circuit to detect an error associated with the function performed by the HW and to generate an error indicator signal or error information to indicate that the error has been detected. In addition, the error detection circuit can be coupled to the functional circuit to provide the location and error type information. In some embodiments, a HW, such as HW 162, can issue transactions towards the fabric and peripherals or storage components, like SRAM or ROM.

In some embodiments, communication bus 156a, communication bus 156b, communication bus 156c, and communication bus 156d can be any type of communication infrastructure bus. A communication bus can include hardware components (e.g., wire, optical, and fiber components) and software components (e.g., communication protocols). In some embodiments, communication bus 156a, communication bus 156b communication bus 156c, and communication bus 156d can include an AMBA bus, an AXI bus, an AHB, an APB, a USB, an OCP bus, a PCIe bus, or any other suitable communication bus or communication infrastructure.

In some embodiments, FIG. 1C illustrates an example of debugging network 120 in system 100, where debugging network 120 includes an aggregation network 170 and a distribution network 180. Similarly, FIG. 1D illustrates another example of debugging network 120 in system 100, where debugging network 120 includes an aggregation network 170a and a distribution network 180a. In some embodiments, aggregation network 170 and aggregation network 170a can have a tree topology to forward error information about error events from the leaf nodes to a root node. Similarly, distribution network 180 and distribution network 180a can also have a tree topology. Leaf nodes can capture error information about error events and forward these error information to the next node of the tree until the error information reaches the root node. The root node can forward the error information about error events to distribution network 180. All nodes of the aggregation network 170, including the root node, can optionally timestamp error events. All nodes of aggregation network 170 can optionally mark the first raised error event. All nodes of aggregation network 170, including the root node, can mask their input error events individually. In some embodiments, distribution network 180 can have a tree topology to forward the error information about error events from the root node to leaf nodes of distribution network 180. Root node of distribution network 180 can receive the error information about error events from aggregation network 170. Leaf nodes of distribution network 180 can perform different actions, such as asserting an interrupt to one or more CPUs or assert HW signals to trigger a special system behavior designed for system 110. Aggregation network 170a and distribution network 180a are an abstraction of aggregation network 170 and distribution network 180, respectively. Descriptions about aggregation network 170 and distribution network 180 are applicable to aggregation network 170a and distribution network 180a.

In some embodiments, as shown in FIG. 1C, aggregation network 170 can include: a first tree formed by a first plurality of leaf nodes, such as a leaf node 173a, a leaf node 173b, a leaf node 173c, and a leaf node 173d; one or more inner nodes of aggregation network 170, such as an inner node 175 and a first root node 171. A node, such as leaf node 173a, leaf node 173b, leaf node 173c, leaf node 173d, inner node 175, and first root node 171, can include a circuit or device having a smaller component. For example, leaf node 173d can include an error register 172 to store error information. Other leaf nodes can include similar storage components, not shown. The plurality of leaf nodes, such as leaf node 173a, leaf node 173b, leaf node 173c, and leaf node 173d, can be coupled to a plurality of functional circuits, such as a functional circuit 177a, a functional circuit 177b, a functional circuit 177c, and a functional circuit 177d, respectively. Similarly, as shown in FIG. 1D, aggregation network 170a can include: a first tree formed by a first plurality of leaf nodes, such as a leafnode 173e, a leafnode 173f, a leafnode 173g, a leafnode 173h, and a leaf node 173i; one or more inner nodes of aggregation network 170a, such as an inner node 175a, inner node 175b, inner node 175c, and a first root node 171a. In general, any node of the aggregation network (leaf nodes, root node, or inner node) can perform the same functions, such as storing the order of occurrence or a timestamp.

In some embodiments, one functional circuit can be coupled to multiple leaf nodes. The plurality of leaf nodes, such as leaf node 173a, leaf node 173b, leaf node 173c, and leaf node 173d, can be coupled to first root node 171. The plurality of leaf nodes, such as leaf node 173a, leaf node 173b, leaf node 173c, and leaf node 173d, can be configured to collect a plurality of error information about a plurality of error events, such as a fabric error event, a hardware error event, a security error event, or a software error event, in the plurality of functional circuits including functional circuit 177a, functional circuit 177b, functional circuit 177c, and functional circuit 177d. In addition, leaf node 173a, leaf node 173b, leaf node 173c, and leaf node 173d can transmit the plurality of error information to first root node 171. First root node 171 can be configured to identify an order of occurrence among the plurality of error events. For a leaf node or an inner node collecting error information from multiple functional circuits about multiple error events, the leaf node or the inner node can determine an order of occurrence among the plurality of error events as well.

In some embodiments, the plurality of error events occurring in functional circuit 177a, functional circuit 177b, functional circuit 177c, and functional circuit 177d can be non-recoverable errors, including hardware errors or software errors, which could lead to a reset of the system. Other errors, which can be recovered from without system reset at runtime can be forwarded to a CPU via interrupt to be resolved in software. In some embodiments, non-recoverable errors can include hardware errors, such as fabric errors, security errors, or other hardware errors. Fabric errors can be caused by the inability of the fabric components to successfully forward transactions and can include invalid addresses or otherwise invalid transaction properties. These fabric errors can be detected by the fabric components. Security errors can be caused by fabric access violations, security violations, or detectable suspicious behavior. Other hardware errors can be detected as well, such as an overflow of internal hardware resources. Non-recoverable software errors can place software into a non-recoverable state and can include memory allocation errors and other unavailable resources detected by the CPU. For example, a non-recoverable software error can include an invalid access error detected by a memory management unit (MMU) by raising an exception to indicate such a non-recoverable software error.

In some embodiments, error events of functional circuit 177a, functional circuit 177b, functional circuit 177c, and functional circuit 177d can be detected by detection circuits in the functional circuits. For example, an error detection circuit can detect the error event based on the transaction details (e.g., destination address) or communication network state (e.g., powered-off target). Error information collected by leaf nodes can include one or more of an error type, a source address of the transaction request, a destination address of the transaction request, a communication bus state, and an identification of the functional circuit. An error type can be selected from a decode error, a security error, a disconnect error (e.g., a power disconnect error), a slave error, or any other error type defined by a communication bus protocol. In some embodiments, there can be multiple types of errors and various ways to detect them. A decode error can be detected if a destination address of a transaction request is not mapped to any target. When a decode error is detected, a bit (e.g., a DECERR bit) can be flagged. Decode errors can be reported by a functional circuit, such as a demultiplexer. A security error can be detected when a security filter detects a request is not allowed to access the destination. A disconnect error can be detected when powered-off blocks could return an error upon access. The disconnect error may be generated by a power-disconnect component in lieu of the powered-off block. A slave error can occur if a write transaction request is sent to a read-only register or if a transaction request is destined to a non-mapped register address in the target's address space.

In some embodiments, aggregation network 170 can include one or more leaf nodes, optional inner nodes, and a root node that are interconnected by a tree network with a common root node. When a non-recoverable error occurs in a subsystem, aggregation network 170 collects, qualifies, and forwards the error to the root node, which can act as a central unit for aggregation network 170.

In some embodiments, each node in aggregation network 170 can have the same design or a copy of a same device. Depending on the location of the device in aggregation network 170, the device can act as leaf node, inner node, or root node. Each node can include multiple input ports and can provide a single output port.

In some embodiments, hardware blocks in a subsystem can report hardware errors by signaling error events to a leaf node where they are captured in a register in the leaf node. CPUs running into software errors set a corresponding bit in a software error register located in the leaf node which will result in an activation of an internal software error event. The stored error information about hardware and software error events can be “sticky,” which means they can only be cleared by a software clear process, according to some embodiments.

In some embodiments, as shown in FIGS. 1C and 1D, in addition to collecting and storing the error information 192 about the error events, the nodes of aggregation network 170 or aggregation network 170a, such as node 190a that can be any of the leaf node, inner node, or root node described herein, can allow to qualify or identify the error signals by a mask signal 193a. In some embodiments, error information 192 can include order information between multiple error events. In some embodiments, order information 191 between multiple error events can be stored separately. The stored error information 192, order information 191, and incoming error event signal 195a can be ANDed with mask signal 193a and then all error information about the error events can be ORed together to generate an aggregated error event signal 195b that is forwarded, via aggregation network 170 or aggregation network 170a, to another node such as inner node 175 and then to the root node such as first root node 171 or first root node 171a, respectively. Error event signal 195a or 195b can be any of the error event signal 195 as shown in aggregation network 170 or aggregation network 170a.

In some embodiments, as shown in FIGS. 1C and 1D, all nodes, such as the leaf nodes 173a-173d, leaf nodes 173e-173i, inner node 175, inner node 175a-175b, and first root node 171, first root node 171a, can capture the occurrence order of the error events or the information where the first error occurred. Such embodiments can allow the software of the debugging network to identify the initiator of the first error event by tracing back the captured information from the root node to the leaf node.

In some embodiments, timestamps can be provided in a node, such as a leaf node. For example, a timestamp can be provided for the first event entering a node or a time stamp can be provided for each error event input. Additionally and alternatively, a subset of error events can be timestamped. The number of timestamps in a node and how they are assigned to events depend on the system requirement and on the topology of the aggregation network (e.g., if a child node provides time stamping, the parent node might not require an additional time stamp implementation).

In some embodiments, in addition to capturing the first raised error event in the aggregation nodes to distinguish follow-up error events from the first raised error events, aggregation network 170 can make aggregation nodes states, including time stamp and first occurred error event, available to read via a bus interface for error analysis by system 100.

In some embodiments, distribution network 180 can include a second tree formed by a second plurality of leaf nodes (such as a leaf node 185a, a leaf node 185b, a leaf node 185c), an inner node 183 of distribution network 180 coupled to the leaf nodes, and a second root node 181, as shown in FIG. 1C. Distribution network 180 can include second root node 181 coupled to first root node 171. The plurality of leaf nodes can be coupled to a plurality of responding functional circuits. For example, leaf node 185a, leaf node 185b, and leaf node 185c can be coupled to a functional circuit 179a, a functional circuit 179b, a functional circuit 179c, a functional circuit 179d, a functional circuit 179e, a functional circuit 179f, and a functional circuit 179g, respectively. In some embodiments, one leaf node can be coupled to multiple responding functional circuits. For example, leaf node 185a can be coupled to functional circuit 179a, functional circuit 179b, and functional circuit 179c. Similarly, as shown in FIG. 1D, distribution network 180a can include a tree formed by a plurality of leafnodes, such as a leafnode 185d, a leafnode 185e, a leafnode 185f, and a leafnode 185g; one or more inner nodes of distribution network 180a, such as an inner node 183a, inner node 183b, and a root node 181a. In general, any node of the distribution network (leaf nodes, root node, or inner node), which can be implemented as node 190b, can perform the same functions as for the node in the aggregation network. In some embodiments, only aggregation nodes in aggregation network 170 store error information, and distribution nodes in distribution network 180 do not store any error information. In some embodiments, node 190b can receive incoming error event signal 195c that can be ANDed with mask signal 193b to generate an aggregated error event signal 195d that is forwarded, via distribution network 180a, to another node such as inner node 183a and then to the leaf node such as leaf node 185d or other leaf nodes. Error event signal 195c or 195d can be any of the error event signal 195 as shown in distribution network 180a.

In some embodiments, second root node 181 can be configured to receive the plurality of error information from first root node 171 and to distribute the plurality of error information to the plurality of responding functional circuits, such as functional circuit 179a-179g, to perform one or more actions based on the plurality of error information and the order of occurrence among the plurality of error events. In some embodiments, the one or more actions performed by responding functional circuits can be triggered by various interrupt signals, such as a FIQ signal, or other interrupt signals.

In some embodiments, distribution network 180 can be formed by connecting different distribution network nodes. The root node of the aggregation network and the root node of the distribution network can be connected together or can be treated as single root node. The root node of the distribution network can spread the error information, which was received from the aggregation network, via the distribution network nodes back to different entities of the various subsystems where the information is used to trigger actions, such as error processing tasks. CPUs, HW components, and other devices can receive the error information.

In some embodiments, the nodes in distribution network 180 can be used to connect to other nodes and optionally provide the error information as separate outputs to the entities, such as functional circuits which act on the error information. Each node forwards the information from the input port to all of its output ports, in which each output port can be masked, according to some embodiments. In this way, a single CPU could be the receiver of the error information or multiple CPUs could be addressed concurrently.

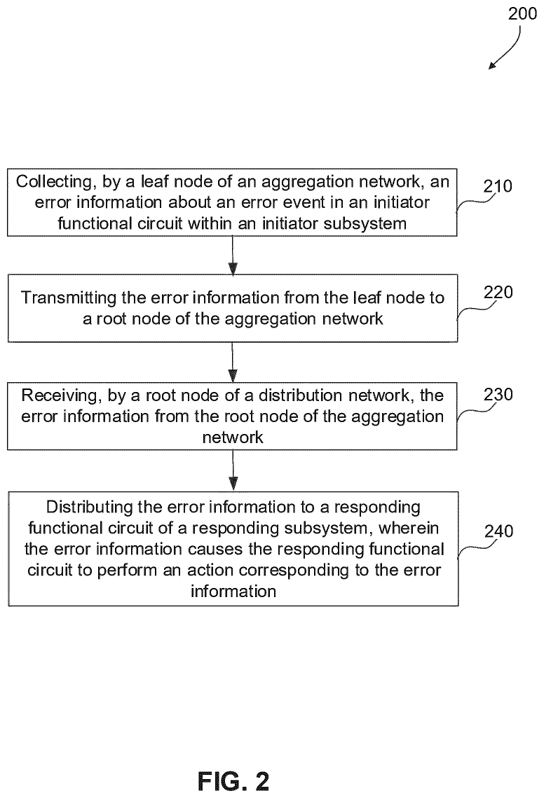

FIG. 2 is an illustration of a method 200 to perform debugging operations using a debugging network, such as debugging network 120, according to some embodiments. For illustrative purposes, the operations illustrated in method 200 will be described with reference to system 100 shown in FIGS. 1A-1D. Other embodiments of system 100 are within the scope of the present disclosure. Also, additional operations may be performed between various operations of method 200 and may be omitted merely for clarity and ease of description. The additional operations can be provided before, during, and/or after method 200, in which one or more of these additional operations are briefly described herein. Moreover, not all operations may be needed to perform the disclosure provided herein. Additionally, some of the operations may be performed simultaneously or in a different order than shown in FIG. 2. In some embodiments, one or more other operations may be performed in addition to or in place of the presently-described operations.

At operation 210, a leaf node of an aggregation network can collect an error information about an error event in an initiator functional circuit in an initiator subsystem. For example, the first leaf node 131 of aggregation network 130 can collect error information 132 about error event 115 in functional circuit 111 in subsystem 101, which can be an initiator functional circuit in an initiator subsystem.

At operation 220, the leaf node of the aggregation network can transmit the error information, such as a notification of an error event, from the leaf node to a root node of the aggregation network. In some embodiments, error information is not forwarded from the leaf node to the root node only the error event is forwarded. Each leaf node can store the error information locally and only forward the error events. For example, first leaf node 131 of aggregation network 130 can transmit error information 132 from first leaf node 131 to first root node 133 of aggregation network 130. In some embodiments, the leaf node or the root node can perform event masking for the error event.

At operation 230, a root node of a distribution network can receive the error information from the root node of the aggregation network. For example, second root node 141 of distribution network 140 can receive error information 132 from first root node 133 of aggregation network 130.

At operation 240, the root node of the distribution network can distribute the error information, such as a notification of an error event, to a responding functional circuit of a responding subsystem, where the error information causes the responding functional circuit to perform an action corresponding to the error information. In some embodiments, the error information is already stored in the aggregation network, while only an error event is distributed to a responding functional circuit of a responding subsystem. For example, second root node 141 of distribution network 140 can distribute error information 132 to functional circuit 112 of subsystem 102, where functional circuit 112 can be an example of a responding functional circuit of a responding subsystem. Error information 132 can cause functional circuit 112 to perform action 116, which can be triggered by an interrupt 119 corresponding to error information 132. In some embodiments, interrupt 119 can be the same as a notification of an error event.

In some embodiments, the aggregation network can include a plurality of leaf nodes, such as leaf nodes 173a-173d in aggregation network 170, coupled to a plurality of functional circuits, such as functional circuits 177a-177d. The plurality of leaf nodes can collect a plurality of error information about error events in the plurality of functional circuits and transmit the plurality of error information to the root node of the aggregation network. For example, leaf nodes 173a-173d in aggregation network 170 can transmit collected error information to root node 171. In addition, root node 171 can identify an order of occurrence among the plurality of error events occurred in the plurality of functional circuits 177a-177d. Root node 171 can further transmit the plurality of error information to root node 181 of distribution network 180 and distribute the plurality of error information to a plurality of responding functional circuits, such as functional circuits 179a-179g. The plurality of responding functional circuits, such as functional circuits 179a-179g, can be configured to perform one or more actions based on the plurality of error information and the order of occurrence among the plurality of error events.

In some embodiments, the plurality of error information includes a first error information with a first timestamp of a first error event from first functional circuit and a second error information with a second timestamp of a second error event from second functional circuit. Root node 171 can identify the order of occurrence between the first error event and the second error event based on the first timestamp and the second timestamp. The identification of the first error event can help to trace the root cause of the error and make it easier to fix the errors.

In some embodiments, aggregation network 170 includes a first tree formed by first plurality of leaf nodes 173a-173d, inner node 175, and root node 171. Distribution network 180 includes a second tree formed by a second plurality of leaf nodes 185a-185c, inner node 183, and root node 181. The error information can be transmitted from a leaf node through inner node 175 to root node 171 of aggregation network 170, and further distributed through inner node 183, root node 185, and leaf nodes 185a, 185b, 185c of distribution network 180. The error information can cause the functional circuit to perform an action corresponding to the error information, such as requesting a system-wide clock stop.

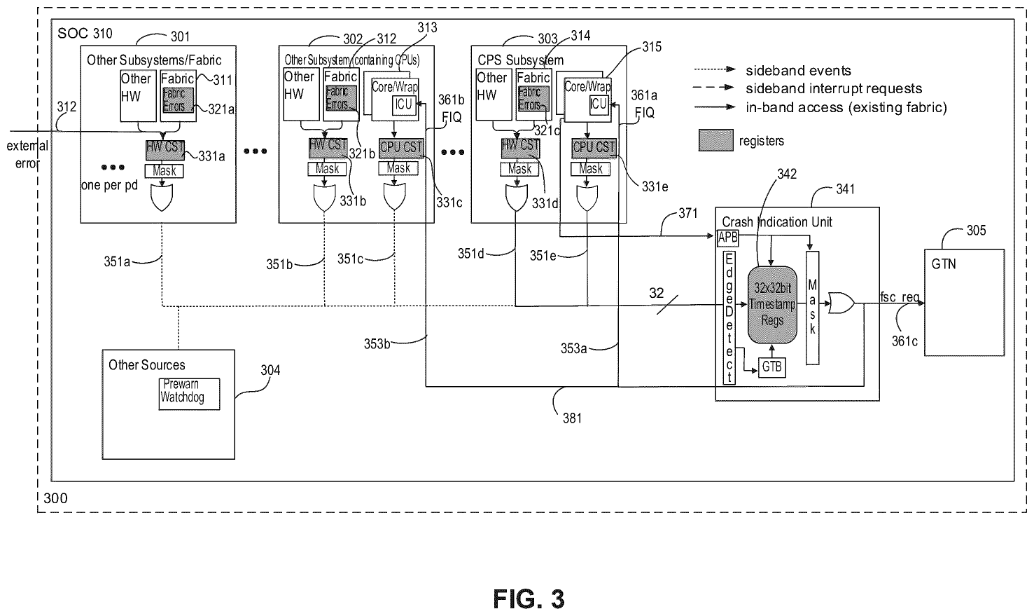

FIG. 3 is an illustration of a system 300 including a debugging network coupled to a plurality of subsystems, according to some embodiments. System 300 can be an example of system 100 shown in FIG. 1.

In some embodiments, system 300 includes a subsystem 301, a subsystem 302, a subsystem 303, a subsystem 304, and a subsystem 305 on a SoC 310. Subsystem 301 includes a functional circuit 311, which can be a fabric; subsystem 302 includes a functional circuit 312, which can be a fabric, and a functional circuit 313, which can be a core or CPU; subsystem 303 includes a functional circuit 314, which can be a fabric, and a functional circuit 315, which can be a core or CPU; subsystem 304 includes a functional circuit, which can be a watchdog; and subsystem 305 includes functional circuits for a Global Trigger Network (GTN).

In some embodiments, system 300 can include a debugging network having an aggregation network and a distribution network. The aggregation network can include a plurality of leaf nodes, such as leaf nodes 331a, 331b, 331c, 331d, and 331e. Each of the leaf nodes is included in a subsystem and coupled to one or more functional circuits. For example, leaf node 331a is included in subsystem 301 and coupled to functional circuit 311 and another HW component. In addition, leaf node 331a can be coupled to an external error source 312. Similarly, leaf node 331b is included in subsystem 302 and coupled to functional circuit 312 and another HW component; leaf node 331c is included in subsystem 302 and coupled to functional circuit 313; leaf node 331d is included in subsystem 303 and coupled to functional circuit 314 and another HW component; and leaf node 331e is included in subsystem 303 and coupled to functional circuit 315.

In some embodiments, the aggregation network can further include a root node, such as a node 341. Leaf nodes 331a, 331b, 331c, 331d, and 331e can be coupled to root node 341 by various communication buses 351a, 351b, 351c, 351d, and 351e, respectively, and can form a crash indication network (CIN). Crash status trigger (CST) registers can be in leaf nodes 331a-331e, which can collect a plurality of error information about error events in the plurality of functional circuits. For example, leaf node 331a can collect error information about an error event 321a, leaf node 331b can collect error information about an error event 321b, and leaf node 331d can collect error information about an error event 321c. The collected error information is also referred to herein as “aggregated error information.” In some embodiments, there may not be any aggregated error information. Instead, only an error event signal is propagated through the aggregation network.

In some embodiments, the aggregated error information can include error information about error events of a fabric, security errors, and other errors from hardware blocks, non-recoverable errors from CPUs, errors from external error sources (such as an RF chip connected to a baseband SoC), and errors from other sources (such as a watchdog timer that is a timer to perform a monitoring function).

In some embodiments, the aggregated error information of error events, such as error event 321a, error event 321b, and error event 321c, can be forwarded to the crash indication unit (CIU) which acts as root node 341 of the aggregation network and stored in register 342. Root node 341 can also act as a root node for the distribution network. For system 300, the distribution network includes root node 341 as the root node for the distribution network, without any leaf nodes. Accordingly, error information stored in register 342 can be forwarded or distributed to the subsystems by way of communication paths 353a and 353b. In some embodiments, there may not be any aggregated error information. Instead, only an error event signal is propagated through the distribution network.

Various entities and subsystems can use the error information to perform corresponding actions, such as stop the system and collect the system state. For example, error information can be distributed to functional circuit 315 of subsystem 303 through communication path 353a to perform an action triggered by an interrupt signal 361a, which can be an FIQ signal. Similarly, error information, such as a notification of an error event, can be distributed back to functional circuit 313 of subsystem 302 through communication path 353b to perform an action triggered by an interrupt signal 361b, which can be an FIQ signal, and distributed to functional circuits of subsystem 305 to perform an action triggered by an interrupt signal 361c, which can be an IRQ signal. In some embodiments, only the error event is distributed back to functional circuits of subsystem 305. If the performed action needs more details about the error, such information can be accessed from the aggregation nodes of the aggregation network. Accordingly, the distributed error information can be treated as a non-maskable FIQ to the CPUs, or other interruption signal to allow a fast halt of operation, a signal that stops all masters by blocking new requests while accepting outstanding responses, or other interrupt signals.

In some embodiments, the distribution network includes a communication path 381 that is used solely by the debugging network and is not used to perform intended functions of SoC 310. In addition, SoC 310 can include a communication path 371 that is only used to perform the intended functions of SoC 310 and is not used by the debugging network.

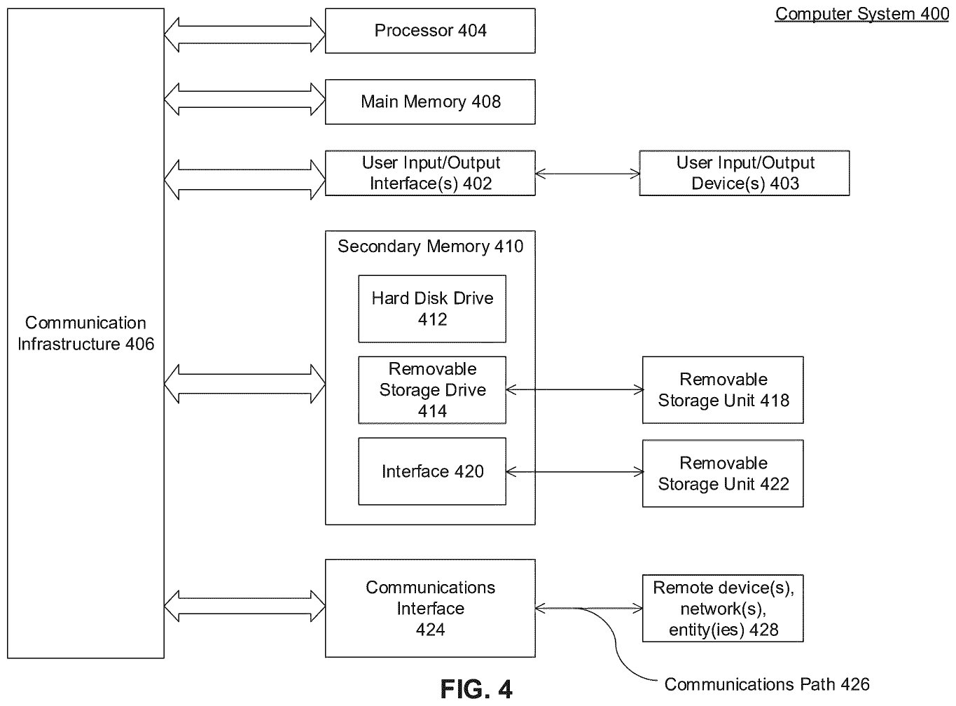

Various aspects can be implemented, for example, using one or more computer systems, such as computer system 400 shown in FIG. 4. Computer system 400 can be any computer capable of performing the functions described herein for system 100 or system 300 including components, such as subsystems, leaf nodes, root nodes, as shown in FIGS. 1A-1D, and 3, and for operations described in method 200 of FIG. 2. Computer system 400 includes one or more processors (also called central processing units, or CPUs), such as a processor 404. Processor 404 is connected to a communication infrastructure 406 (e.g., a bus). Computer system 400 also includes user input/output device(s) 403, such as monitors, keyboards, pointing devices, etc., that communicate with communication infrastructure 406 through user input/output interface(s) 402. Computer system 400 also includes a main or primary memory 408, such as random access memory (RAM). Main memory 408 may include one or more levels of cache. Main memory 408 has stored therein control logic (e.g., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to some aspects, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 408, the removable storage unit 418, the removable storage unit 422 can store instructions that, when executed by processor 404, cause processor 404 to perform operations for system 100 or system 300 including components, such as subsystems, leaf nodes, root nodes, as shown in FIGS. 1A-1D, and 3, and for operations described in method 200 of FIG. 2.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 400, main memory 408, secondary memory 410 and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings in this disclosure, it will be apparent to persons skilled in the relevant art(s) how to make and use aspects of the disclosure using data processing devices, computer systems and/or computer architectures other than that shown in FIG. 4. In particular, aspects may operate with software, hardware, and/or operating system implementations other than those described herein.

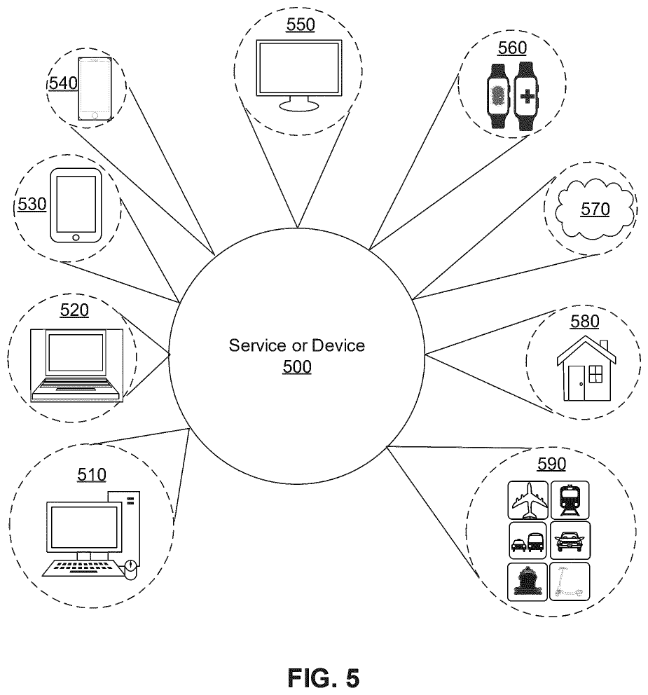

FIG. 5 is an illustration of exemplary systems or devices that can include the disclosed embodiments. System or device 500 can incorporate one or more of the disclosed embodiments in a wide range of areas. For example, system or device 500 can be implemented in one or more of a desktop computer 510, a laptop computer 520, a tablet computer 530, a cellular or mobile phone 540, and a television 550 (or a set-top box in communication with a television).

Also, system or device 500 can be implemented in a wearable device 560, such as a smartwatch or a health-monitoring device. In some embodiments, the smartwatch can have different functions, such as access to email, cellular service, and calendar functions. Wearable device 560 can also perform health-monitoring functions, such as monitoring a user's vital signs and performing epidemiological functions (e.g., contact tracing and providing communication to an emergency medical service). Wearable device 560 can be worn on a user's neck, implantable in user's body, glasses or a helmet designed to provide computer-generated reality experiences (e.g., augmented and/or virtual reality), any other suitable wearable device, and combinations thereof.

Further, system or device 500 can be implemented in a server computer system, such as a dedicated server or on shared hardware that implements a cloud-based service 570. System or device 500 can be implemented in other electronic devices, such as a home electronic device 580 that includes a refrigerator, a thermostat, a security camera, and other suitable home electronic devices. The interconnection of such devices can be referred to as the “Internet of Things” (IoT). System or device 500 can also be implemented in various modes of transportation 590, such as part of a vehicle's control system, guidance system, and/or entertainment system.

The systems and devices illustrated in FIG. 5 are merely examples and are not intended to limit future applications of the disclosed embodiments. Other example systems and devices that can implement the disclosed embodiments include portable gaming devices, music players, data storage devices, and unmanned aerial vehicles.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” other components, etc.) may be described or claimed as “configured” to perform one or more tasks or operations. This formulation—[entity]configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function]construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A system, comprising:
a first subsystem coupled to a second subsystem by a communication circuit; and
a debugging network, comprising:
an aggregation network including a first leaf node coupled to a first functional circuit in the first subsystem and a first root node coupled to the first leaf node, wherein the first leaf node is configured to collect a first error information about a first error event in the first functional circuit and to transmit the first error information to the first root node; and
a distribution network including a second root node coupled to the first root node and to a second functional circuit in the second subsystem, wherein the second root node is configured to receive the first error information from the first root node and to distribute the first error information to the second functional circuit to perform an action corresponding to the first error information.

2. The system of claim 1, further comprising:
a third subsystem and a fourth subsystem coupled to the first subsystem and the second subsystem by the communication circuit, wherein the aggregation network further includes a second leaf node coupled to a third functional circuit in the third subsystem, and wherein:
the second leaf node is configured to collect a second error information about a second error event in the third functional circuit and to transmit the second error event to the first root node;
the first root node is configured to identify an order of occurrence between the first error event and the second error event; and
the second root node is configured to receive the second error information and to distribute the second error information to a fourth functional circuit in the fourth subsystem to perform a second action corresponding to the second error information.

3. The system of claim 2, wherein the first error information includes a first timestamp of the first error event and the second error information includes a second timestamp of the second error event, and wherein the first root node is configured to identify the order of occurrence between the first error event and the second error event.

4. The system of claim 1, wherein the first error information is stored in a register of the first leaf node.

5. The system of claim 1, further comprising:
a first communication path coupling a starting functional circuit of the first subsystem to an end functional circuit of the second subsystem; and
a second communication path coupling the first functional circuit of the first subsystem and the second functional circuit of the second subsystem to the aggregation network and the distribution network, and wherein the first communication path and the second communication path differ in at least one functional circuit.

6. The system of claim 1, wherein the action includes at least one of an action to request a system-wide clock stop, an action to scan-dump, an action to interrupt one or more processors, an action to freeze an initiator subsystem or a responding subsystem and to collect system state, and an action to collect error information regarding a crash dump.

7. The system of claim 1, wherein the action is triggered by an interrupt signal based on an error event received by the second functional circuit, and wherein the interrupt signal includes at least one of a fast interrupt request (FIQ) signal, a non-maskable interrupt (NMI) signal, and an Interrupt ReQuest (IRQ) signal.

8. The system of claim 1, wherein at least one of the first functional circuit or the second functional circuit includes a processor, a controller, a peripheral component, and a storage component in a system-on-chip (SoC).

9. The system of claim 1, wherein the aggregation network further includes a first tree with a first plurality of leaf nodes and a first inner node, and wherein the distribution network further includes a second tree with a second plurality of leaf nodes and a second inner node of the distribution network.

10. The system of claim 1, wherein the first leaf node or the first root node is configured to perform event masking for the first error event.

11. The system of claim 1, wherein the first error event includes at least one of a non-recoverable error, a fabric error in the communication circuit, a security error caused by a security violation, an overflow of an internal hardware resource, a memory allocation error, and an invalid access detected by a memory controller.

12. A method, comprising:
collecting, by a leaf node of an aggregation network, an error information about an error event in an initiator functional circuit of an initiator subsystem;
transmitting the error information from the leaf node to a root node of the aggregation network;
receiving, by a root node of a distribution network, the error information from the root node of the aggregation network; and
distributing the error information to a responding functional circuit of a responding subsystem, wherein the error information causes the responding functional circuit to perform an action corresponding to the error information.

13. The method of claim 12, wherein the aggregation network includes a plurality of leaf nodes coupled to a plurality of functional circuits, and the method further comprises:
collecting, by the plurality of leaf nodes, a plurality of error information about error events in the plurality of functional circuits;
transmitting, by the plurality of leaf nodes, the plurality of error information to the root node of the aggregation network;
identifying, by the root node of the aggregation network, an order of occurrence among the plurality of error events;
transmitting, by the root node of the aggregation network, the plurality of error information to the root node of the distribution network; and
distributing the plurality of error information to a plurality of responding functional circuits, wherein the plurality of responding functional circuits are configured to perform one or more actions based on the plurality of error information and the order of occurrence among the plurality of error events.

14. The method of claim 13, wherein the plurality of error information includes a first error information with a first timestamp of a first error event in a first functional circuit and a second error information with a second timestamp of a second error event in a second functional circuit, and wherein identifying the order of occurrence comprises identifying the order of occurrence between the first error event and the second error event.

15. The method of claim 12, the action includes at least one of an action to request a system-wide clock stop, an action to scan-dump, an action to interrupt one or more processors, an action to freeze the initiator subsystem or the responding subsystem and to collect system state, and an action to collect error information regarding a crash dump.

16. The method of claim 12, wherein the aggregation network includes a first tree with a first plurality of leaf nodes and a first plurality of inner nodes, and wherein the distribution network includes a second tree with a second plurality of leaf nodes and a second plurality of inner nodes, and wherein:
the transmitting the error information comprises transmitting the error information from the leaf node of the aggregation network through first the plurality of inner nodes to the root node of the aggregation network; and
the distributing the error information to the responding subsystem comprises distributing the error information through the second plurality of inner nodes and the second plurality of leaf nodes.

17. A debugging system, comprising:
an aggregation network including leaf nodes coupled to functional circuits and a first root node coupled to the leaf nodes, wherein the leaf nodes are configured to collect error information about error events in the functional circuits and to transmit the error information to the first root node, and wherein the first root node is configured to identify an order of occurrence among the error events; and
a distribution network including a second root node coupled to the first root node and to responding functional circuits, wherein the second root node is configured to receive the error information from the first root node and to distribute the error information to the responding functional circuits to perform an action based on the error information and the order of occurrence among the error events.

18. The debugging system of claim 17, wherein the action includes at least one of an action to request a system-wide clock stop, an action to scan-dump, an action to freeze an initiator subsystem or a responding subsystem and to collect system state, an action to interrupt one or more processors, and an action to collect error information regarding a crash dump.

19. The debugging system of claim 17, wherein the action is triggered by an interrupt signal based on an error event received by the responding functional circuits, wherein the interrupt signal includes at least one of a fast interrupt request (FIQ) signal, a non-maskable interrupt (NMI) signal, and an Interrupt ReQuest (IRQ) signal.

20. The debugging system of claim 17, wherein the functional circuits and the responding functional circuits are coupled by a communication circuit, and the error events include at least one of a non-recoverable error, a fabric error occurred in the communication circuit, a security error caused by a security violation, an overflow of an internal hardware resource, a memory allocation error, and an invalid access detected by a memory controller.

21. A system, comprising:
a first subsystem coupled to a second subsystem by a communication circuit; and
a debugging network, comprising:
an aggregation network including a first tree having a first leaf node coupled to a first functional circuit in the first subsystem and a first root node coupled to the first leaf node, wherein the first leaf node is configured to collect an error information about an error event in the first functional circuit, store the error information in a register of the first leaf node, and transmit the error information to the first root node, and wherein the first leaf node or the first root node is configured to perform event masking for the error event; and
a distribution network including a second tree having a second root node coupled to the first root node and to a second functional circuit in the second subsystem, wherein the second root node is configured to receive the error information from the first root node and to distribute the error information to the second functional circuit to perform an action corresponding to the error information.
